(19) United States
(12) Patent Application Publication
(10) Pub. No.: US 2016/0177693 A1
(43) Pub. Date: Jun. 23, 2016

(54) COMPOSITIONS AND METHODS OF IMPROVING HYDRAULIC FRACTURE NETWORK

(71) Applicants: Ahmed M. Gomaa, Spring, TX (US); Qi Qu, Spring, TX (US); Hong Sun, Houston, TX (US); Scott G. Nelson, Cypress, TX (US)

(72) Inventors: Ahmed M. Gomaa, Spring, TX (US); Qi Qu, Spring, TX (US); Hong Sun, Houston, TX (US); Scott G. Nelson, Cypress, TX (US)

(73) Assignee: Baker Hughes Incorporated, Houston, TX (US)

(21) Appl. No.: 14/971,139

(22) Filed: Dec. 16, 2015

Related U.S. Application Data
(60) Provisional application No. 62/092,970, filed on Dec. 17, 2014.
(60) Provisional application No. 62/092,980, filed on Dec. 17, 2014.

(51) Int. Cl. E21B 43/26; C09K 8/88; C09K 8/90; C09K 8/70; C09K 8/68

(52) U.S. Cl. CPC E21B 43/26; C09K 8/70; C09K 8/68; C09K 8/90; C09K 8/882

(57) ABSTRACT

A diverter fluid includes an aqueous carrier fluid, and a plurality of water-swellable polymer particles having a size of 0.01 to 100,000 micrometers. A method of hydraulically fracturing a subterranean formation penetrated by a reservoir includes injecting a fracturing fluid into the formation at a pressure sufficient to create or enlarge a fracture, injecting a diverter fluid into the formation, and injecting a fracturing fluid into the formation, wherein the flow of the fracturing fluid is impeded by the diverting agent and a surface fracture area of the fracture is increased. A method of controlling the downhole placement of a diverting agent is also disclosed, including injecting a diverter fluid including the diverting agent and an aqueous carrier fluid selected so that the polymer particles are fully swelled after contacting the aqueous carrier fluid for an amount of time sufficient to achieve a desired downhole placement.

### CROSS REFERENCE TO RELATED APPLICATIONS

This application claims the benefit of an earlier filing date from U.S. Provisional Application Ser. No. 62/092,970 filed Dec. 17, 2014 and from U.S. Provisional Application Ser. No. 62/092,980 filed Dec. 17, 2014, the entire disclosures of which are incorporated herein by reference.

### BACKGROUND

Hydraulic fracturing is a stimulation process for creating high-conductivity communication with a large area of a subterranean formation. The process increases the effective wellbore area within the formation so that entrapped oil or gas production can be accelerated. The efficiency of the process is often measured by the total amount of contacted surface area that results from the stimulation treatment.

During hydraulic fracturing, a fracturing fluid is pumped at pressures exceeding the fracture pressure of the targeted reservoir rock in order to create or enlarge fractures within the subterranean formation penetrated by the wellbore. The fluid used to initiate hydraulic fracturing is often referred to as the “pad.” In some instances, the pad can contain fine particulates, such as fine mesh sand, for fluid loss control. In other instances, the pad can contain particulates of larger grain in order to abrade perforations or near-wellbore tortuosity.

Once the fracture is initiated, subsequent stages of fluid containing chemical agents, as well as proppants, are pumped into the created fracture. The fracture generally continues to grow during pumping and the proppants remain in the fracture in the form of a permeable pack that serves to prop the fracture open. Once the treatment is completed, the fracture closes onto the proppants. The proppants keep the created fracture open, providing a highly conductive pathway for hydrocarbons and/or other formation fluids to flow into the wellbore.

A large number of parameters affect the total created fracture area within a given formation, including the viscosity of the fracturing fluid, both upon injection into the wellbore and after injection. Fractures propagated with low viscosity fluids such as slickwater exhibit smaller fracture widths than those propagated with higher viscosity fluids. In addition, low viscosity fluids facilitate increased fracture complexity in the reservoir during stimulation. This often results in the development of greater created fracture area from which hydrocarbons can flow into higher conductive fracture pathways. However, the small fracture widths created, combined with low proppant transport capability of slickwater fracturing fluids, make it extremely difficult to place proppant quantities large distances away from the wellbore. This can result in new fractures being created that are unpropped and will close, resulting in greatly impaired hydrocarbon flow.

In some shale formations, an excessively long primary fracture can result perpendicular to the minimum principle stress orientation. Typically, pumping additional fracturing fluid into the wellbore simply adds to the width of the planar or primary fracture. In most of these instances, primary fractures dominate and secondary fractures are limited. Fracturing treatments which create predominately long planar fractures are characterized by a low contacted fracture face surface area. Production of hydrocarbons from the fracturing network created by such treatments is proportionally limited by the lower total fracture area that is created within the producing reservoir.

Recently, attention has been directed to alternatives for increasing the productivity of hydrocarbons far field from the wellbore as well as near wellbore. Particular attention has been focused on increasing the productivity of low permeability formations, including shale. Methods have been especially tailored to the stimulation of discrete intervals along the horizontal wellbore resulting in perforation clusters. While the total contacted fracture area within the formation is increased by such methods, potentially productive reservoir areas between the clusters are often not stimulated. This decreases the efficiency of the stimulation operation. There accordingly remains a need for methods that will increase the fracture surface area created within the formation.

### BRIEF DESCRIPTION

A diverter fluid comprises an aqueous carrier fluid, and a plurality of water-swellable polymer particles having a size of 0.01 to 100,000 micrometers, preferably 1 to 10,000 micrometers, more preferably 50 to 5,000 micrometers.

A method of controlling the downhole placement of a diverting agent in a subterranean formation comprises injecting into the formation the above-described diverter fluid, wherein the aqueous carrier fluid is selected so that the polymer particles are fully swelled after contacting the aqueous carrier fluid for an amount of time sufficient to achieve a desired downhole placement.

A method of hydraulically fracturing a subterranean formation penetrated by a reservoir or a well comprises injecting a fracturing fluid into the formation at a pressure sufficient to create or enlarge a fracture; injecting the diverter fluid into the formation; and injecting a fracturing fluid into the formation, wherein the flow of the fracturing fluid is impeded by the diverting agent and a surface fracture area of the fracture is increased.

A method of hydraulically fracturing a subterranean formation penetrated by a reservoir, the method comprising injecting a fracturing fluid into the formation at a pressure sufficient to create or enlarge a primary fracture; determining a bottomhole treating pressure within the well; injecting into the formation the diverter fluid; comparing the determined bottomhole treating pressure with a pre-determined targeted bottomhole treating pressure; and injecting a fracturing fluid into the formation, wherein the flow of the fracturing fluid to the loss zone is impeded by the diverting agent and a surface fracture area is increased.

A method of hydraulically fracturing a subterranean formation penetrated by a well, the method comprising, injecting a fracturing fluid into the formation at a pressure sufficient to create or enlarge a fracture; determining a surface pressure at or near the surface of the well; injecting into the formation the diverter fluid to divert a flow of fluid from a highly conductive zone to a less conductive; comparing the determined surface pressure with a targeted surface pressure; and altering a stress in the well to increase the surface area of the fracture, wherein altering is by varying an injection rate of the fracturing fluid, varying the bottomhole pressure of the well, varying the density of the fracturing fluid, or a combination comprising at least one of the foregoing.

A method of hydraulically fracturing a subterranean formation penetrated by a well, the method comprising, injecting a fluid into the formation at a pressure sufficient to create or enlarge a primary fracture; monitoring an operational parameter and comparing the operational parameter after injecting of the fluid into the formation with a pre-determined value for the operational parameter, wherein the operational parameter is the injection rate of the fluid, the density of the fluid, and the bottomhole treating pressure of the well; injecting the diverter fluid to divert the flow of fluid from a highly conductive zone to a less conductive zone; comparing the operational parameter injecting the diverter fluid with the pre-determined value for the operational parameter; altering a stress in the well to increase the surface area of the fracture, wherein altering is by varying an injection rate of the fracturing fluid, varying the bottomhole pressure of the well, varying the density of the fracturing fluid, or a combination comprising at least one of the foregoing.

A method of hydraulically fracturing a subterranean formation penetrated by a well, the method comprising, injecting a fracturing fluid into the formation at a first pressure sufficient to create or enlarge a fracture having a first surface area; injecting into the formation a flow of the diverter fluid, wherein the flow of diverter fluid proceeds from a highly conductive zone to a less conductive zone; and injecting into the formation additional fracturing fluid at a second pressure, wherein the second pressure is greater than the first pressure to increase a surface area of the fracture to a second surface area, wherein the second fracture area is greater than a fracture area created from a substantially similar method without employing the injecting into the formation the flow of the diverter fluid.

A method of hydraulically fracturing a subterranean formation penetrated by a well, the method comprising, injecting a fluid into the formation at a pressure sufficient to create or enlarge a primary fracture; monitoring an operational parameter and comparing the operational parameter after injecting of the fluid into the formation with a pre-determined value for the operational parameter, wherein the operational parameter is the injection rate of the fluid, the density of the fluid, and the bottomhole treating pressure of the well; injecting the diverter fluid to divert the flow of fluid from a highly conductive zone to a less conductive zone; comparing the operational parameter injecting the diverter fluid with the pre-determined value for the operational parameter; injecting a flow of a fracturing fluid into the formation, wherein the flow of the fracturing fluid to the less conductive zone is impeded by the diverting agent to increase a surface area of the primary fracture.

The above described and other features are exemplified by the following Detailed Description, Examples, and Claims.

### DETAILED DESCRIPTION

A detailed description of one or more embodiments is presented herein by way of exemplification and not limitation.

It has been discovered by the inventors hereof that the fracture surface area of a formation can be increased by treating the formation with a diverter fluid that contains water-swellable polymer particles, and further that the type of fluid can dictate the timing of the swelling of the polymer particles. The diverter fluid accordingly has a relatively lower viscosity upon injection and initial distribution in the well. The particles then swell in the presence of water, thereby increasing the differential pressure across the particles. The associated increase in net pressure within the fracture opens other fractures to then be further propagated by the next fracturing fluid. Use of the diverter fluid therefore increases the surface area of the fracture, by increasing the size of the fracture, the complexity of the fracture, the number of individual fractures, second diverter, or a combination comprising at least one of the foregoing.

In still another advantageous feature, use of the diverter fluid can increase the surface area of the fracture not only at the perforation area and near the wellbore, but also at a distance from the wellbore. Thus in another embodiment, controlling the timing of swelling can allow for control over the location of diversion within a formation. Use of a particular diverter fluid can increase the surface area of the fracture not only at the perforation area and near the wellbore, but also at a distance from the wellbore. A method of controlling the downhole placement of a diverting agent in a subterranean formation therefore represents one aspect of the present disclosure. For example, water-swellable particles having increased swelling time can be desirably used to increase the surface area of a fracture at a distance from the wellbore. The diverter fluid containing the particles can accordingly be transported to an area distant from the injection site before swelling appreciably.

In another embodiment, the diverter fluid further comprises a lightweight particulate different from the water-swellable polymer particles. The lightweight particulate, for example sand, is selected to increase friction between the polymer particles, and between the polymer and the walls of the formation. The lightweight particulates in effect roughen the surface area of the swelled particles, which in turn can significantly increase the friction pressure of the diverter fluid.

In the methods described herein, the diverter fluid comprising water-swellable polymer particles, optionally in combination with the lightweight particulates, can be used to control fluid loss to natural fractures and can be introduced into productive zones of a formation having various permeabilities. The diverter fluid is capable of diverting a well treatment fluid from a highly conductive fracture to less conductive fractures within a subterranean formation.

Without being bound by theory, swelled polymer particles can bridge the flow spaces inside the fractures within a subterranean formation. For example, when employed in acid fracturing, the swelled polymer particles are of sufficient size to bridge the flow space (created from the reaction of the injected acid with the reservoir rock) without penetration of the matrix. The pressure increase through the bridged flow space increases the flow resistance and diverts treatment fluid to less permeable zones of the formation. It is alternatively (or additionally possible that swelled polymer particles bridge the flow spaces on the face of the formation and form a filter cake. For example, when employed in acid fracturing, the swelled polymer particles are of sufficient size to bridge the flow space (created from the reaction of the injected acid with the reservoir rock) without penetration of the matrix. By being filtered at the face of the formation, a relatively impermeable or low permeability filter cake is created on the face of the formation. The pressure increase through the filter cake also increases the flow resistance and diverts treatment fluid to less permeable zones of the formation. Other mechanisms are also possible.

The shape of the water-swellable polymer particles is not critical, and can be regular or irregular, for example spherical, ovoid, polyhedral, fibrous, stranded, or braided. In an embodiment, the water-swellable polymer particles are in the form of beads having an approximately spherical shape. The particles can further have pores or spaces between the polymer chains that admits entrance of a fluid or other particles therein. The size distribution of the swelled polymer particles (optionally together with adsorbed lightweight particulates) should be sufficient to block the penetration of the fluid into the high permeability zone of the formation. The fluid is more easily diverted when at least 60%, more preferably 80%, of the swelled polymer particles (optionally together with adsorbed lightweight particulates) within the diverter fluid have an average largest diameter of 0.01 to 100,000 micrometers, preferably 1 to 10,000 micrometers, more preferably 50 to 5,000 micrometers.

When used in stimulation operations, the size of the swelled polymer particles (optionally together with adsorbed lightweight particulates) is such that a bridge can be formed on the face of the rock. Alternatively, the size can be such that they are capable of flowing into the fracture and thereby pack the fracture in order to temporarily reduce the conductivity of at least some of the fractures in the formation.

The water-swellable polymer particles (optionally together with adsorbed lightweight particulates) can be present in the diverter fluid in a concentration of 0.01 to 200 pounds per thousand gallons, specifically, 0.1 to 100 pounds per thousand gallons, more specifically, 1 to 80 pounds per thousand gallons.

The polymer particles are selected so as to be water-swellable, that is, to expand to a swelled state when contacted with an aqueous fluid, for example, the carrier fluid of the diverter fluid. The polymer particles can comprise an absorbent polymer, for example, a superabsorbent polymer (SAP). In some embodiments, the polymer is crosslinked, for example the polymer has internal crosslinks, surface crosslinks, or a combination comprising at least one of the foregoing.

A superabsorbent polymer comprises a hydrophilic network that can retain large amounts of aqueous fluid relative to the weight of the polymer particle (e.g., in a dry state, the superabsorbent polymer absorbs and retains a weight amount of water equal to or greater than its own weight). The polymer can comprise a variety of organic polymers that can react with or absorb water and swell when contacted with an aqueous fluid. Examples of such polymers include a polysaccharide, poly(C₁₋₈ alkyl (meth)acrylate)s, poly(hydroxyC₁₋₈ alkyl (meth)acrylate)s such as (2-hydroxyethyl acrylate), poly((meth)acrylamide), poly(vinyl pyrrolidine), poly(vinyl acetate), and the like. The foregoing are inclusive of copolymers, for example copolymers of (meth)acrylamide with maleic anhydride, vinyl acetate, ethylene oxide, ethylene glycol, or acrylonitrile, or a combination comprising at least one of the foregoing. A combination of different polymers can be used.

Exemplary polysaccharides include starch, cellulose, xanthan gum, agar, pectin, alginic acid, tragacanth gum, pluran, gellan gum, tamarind seed gum, cardlan gum, guar gum, arabic, glucomannan, chitin, chitosan, hyaluronic acid, and combinations comprising at least one of the foregoing.

The superabsorbent polymer can comprise guar gum and can be natural guar gum and/or enzyme treated guar gum, for example natural guar gum with galactosidase, mannosidase, or other enzymes. The guar gum can further be a galactomannan derivative prepared by treating natural guar gum to introduce carboxyl groups, hydroxy alkyl groups, sulfate groups, phosphate groups, or combinations comprising at least one of the foregoing. A polysaccharide other than guar can also be included. Exemplary polysaccharides include starch, cellulose, carrageenan, xanthan gum, agar, pectin, alginic acid, tragacanth gum, pluran, gellan gum, tamarind seed gum, cardlan, gum arabic, glucomannan, chitin, chitosan, hyaluronic acid, and the like.

In some embodiments, the superabsorbent polymer can be prepared by polymerization of a nonionic, anionic, or cationic monomers, or a combination comprising at least one of the foregoing. Polymerization to form the superabsorbent polymer can include free radical polymerization, solution polymerization, gel polymerization, emulsion polymerization, dispersion polymerization, or suspension polymerization. The polymerization can be performed in an aqueous phase, an inverse emulsion, or an inverse suspension.

Examples of nonionic monomers for preparing the superabsorbent polymer include (meth)acrylamide, alkyl-substituted (meth)acrylamides, aminoalkyl-substituted (meth)acrylamides, vinyl alcohol, vinyl acetate, allyl alcohol, C₁₋₈ alkyl (meth)acrylates, hydroxyl C₁₋₈ alkyl (meth)acrylates such as hydroxyethyl (meth)acrylate, N-vinylformamide, N-vinylacetamide, and (meth)acrylonitrile. As used herein, “poly((meth)acrylamide)s” includes polymer comprising units derived from (meth)acrylamide, alkyl-substituted (meth)acrylamides such as N—C₁₋₈ alkyl (meth)acrylamides and N,N-di(C₁₋₈ alkyl) (meth)acrylamides, dialkylaminoalkyl-substituted (meth)acrylamides such as (N,N-di(C₁₋₈ alkyl)amino)C₁₋₈ alkyl-substituted (meth)acrylamides. Specific examples of the foregoing monomers include methacrylamide, N-methyl acrylamide, N-methyl methacrylamide, N,N-dimethyl acrylamide, N-ethyl acrylamide, N,N-diethyl acrylamide, N-cyclohexyl acrylamide, N-benzyl acrylamide, N,N-dimethylaminopropyl acrylamide, N,N-dimethylaminoethyl acrylamide, N-tert-butyl acrylamide, or a combination comprising at least one of the foregoing can be used. In an embodiment, the poly((meth)acrylamide) is a copolymer of methacrylamide with maleic anhydride, vinyl acetate, ethylene oxide, ethylene glycol, or acrylonitrile, or a combination comprising at least one of the foregoing.

Examples of anionic monomers include ethylenically-unsaturated anionic monomers having acidic groups, for example, a carboxylic group, a sulfonic group, a phosphonic group, a salt thereof, the corresponding anhydride or acyl halide, or a combination comprising at least one of the foregoing acidic groups. For example, the anionic monomer can be (meth)acrylic acid, ethacrylic acid, maleic acid, maleic anhydride, fumaric acid, itaconic acid, α-chloroacrylic acid, β-cyanoacrylic acid, β-methylacrylic acid, α-phenylacrylic acid, β-acryloyloxypropionic acid, sorbic acid, α-chlorosorbic acid, 2′-methylisocrotonic acid, cinnamic acid, p-chlorocinnamic acid, β-stearyl acid, citraconic acid, mesaconic acid, glutaconic acid, aconitic acid, 2-acrylamido-2-methylpropanesulfonic acid, allyl sulfonic acid, vinyl sulfonic acid, allyl phosphonic acid, vinyl phosphonic acid, or a combination comprising at least one of the foregoing can be used.

Examples of cationic monomers include (N,N-di(C₁₋₈alkylamino)(C₁₋₈alkyl) (meth)acrylates (e.g., N,N-dimethylaminoethyl acrylate and N,N-dimethylaminoethyl methacrylate), (wherein the amino group is subsequently quaternized with, e.g., a methyl chloride), diallyldimethyl ammonium chloride, or any of the foregoing alkyl-substituted (meth)acrylamides and dialkylaminoalkyl-substituted (meth)acrylamides, such as (N,N-di(C₁₋₈alkyl)amino)C₁₋₈alkyl acrylamide, and the quaternary forms thereof such as acrylamidopropyl trimethyl ammonium chloride.

The superabsorbent polymer can comprise both cationic and anionic monomers. The cationic and anionic monomers can occur in various stoichiometric ratios, for example, a ratio of 1:1. One monomer can be present in a greater stoichiometric amount than the other monomer. Examples of amphoteric superabsorbent polymers include terpolymers of nonionic monomers, anionic monomers, and cationic monomers.

The superabsorbent polymer can include a plurality of crosslinks among the polymer chains of the superabsorbent polymer. The crosslinks can be covalent and result from crosslinking the polymer chains using a crosslinker. The crosslinker can be an ethylenically-unsaturated monomer that contains, for example, two sites of ethylenic unsaturation (i.e., two ethylenically unsaturated double bonds), an ethylenically unsaturated double bond and a functional group that is reactive toward a functional group (e.g., an amide group) of the polymer chains of the superabsorbent polymer, or several functional groups that are reactive toward functional groups of the polymer chains of the superabsorbent polymer. The degree of crosslinking can be selected so as to control the amount of swelling of the superabsorbent polymer. For example, the degree of crosslinking can be used to control the amount of fluid absorption or the volume expansion of the superabsorbent polymer. Accordingly, when the polymer particles comprise a superabsorbent polymer, the degree of crosslinking can be used to control the amount of fluid absorption or the volume expansion of the polymer particles.

Exemplary crosslinkers include a di(meth)acrylamide of a diamine such as a diacrylamide of piperazine, a C₁₋₈ alkylene bisacrylamide such as methylene bisacrylamide and ethylene bisacrylamide, an N-methylol compounds of an unsaturated amide such as N-methylol methacrylamide or N-methylol acrylamide, a (meth)acrylate esters of a di-, tri-, or tetrahydroxy compound such as ethylene glycol diacrylate, poly(ethyleneglycol) di(meth)acrylate, trimethylopropane tri(meth)acrylate, ethoxylated trimethylol tri(meth)acrylate, glycerol tri(meth)acrylate), ethoxylated glycerol tri(meth)acrylate, pentaerythritol tetra(meth)acrylate, ethoxylated pentaerythritol tetra(meth)acrylate, butanediol di(meth)acrylate), a divinyl or diallyl compound such as allyl (meth)acrylate, alkoxylated allyl(meth)acrylate, diallylamide of 2,2′-azobis(isobutyric acid), triallyl cyanurate, triallyl isocyanurate, maleic acid diallyl ester, polyallyl esters, tetraallyloxyethane, triallylamine, and tetraallylethylene diamine, a diols polyol, hydroxyallyl or acrylate compounds, and allyl esters of phosphoric acid or phosphorous acid; water soluble diacrylates such as poly(ethylene glycol) diacrylate (e.g., PEG 200 diacrylate or PEG 400 diacrylate). A combination comprising any of the above-described crosslinkers can also be used.

As described above, the superabsorbent polymer is in the form of a polymer particle. The particle can include surface crosslinks at the outer surface of the particle. The surface crosslinks can result from addition of a surface crosslinker to the superabsorbent polymer particle and subsequent heat treatment. The surface crosslinks can increase the crosslink density of the particle near its surface with respect to the crosslink density of the interior of the particle. Surface crosslinkers can also provide the particle with a chemical property that the superabsorbent polymer did not have before surface crosslinking, and can control the chemical properties of the particle, for example, hydrophobicity, hydrophilicity, and adhesiveness of the superabsorbent polymer to other materials, for example, minerals (e.g., silicates) or other chemicals, for example, petroleum compounds (e.g., hydrocarbons, asphaltene, and the like).

Surface crosslinkers have at least two functional groups that are reactive with a group of the polymer chains, for example, any of the above crosslinkers, or crosslinkers having reactive functional groups such as an acid (including carboxylic, sulfonic, and phosphoric acids and the corresponding anions), an amide, an alcohol, an amine, or an aldehyde. Exemplary surface crosslinkers include polyols, polyamines, polyaminoalcohols, and alkylene carbonates, such as ethylene glycol, diethylene glycol, triethylene glycol, polyethylene glycol, glycerol, polyglycerol, propylene glycol, diethanolamine, triethanolamine, polypropylene glycol, block copolymers of ethylene oxide and propylene oxide, sorbitan fatty acid esters, ethoxylated sorbitan fatty acid esters, trimethylolpropane, ethoxylated trimethylolpropane, pentaerythritol, ethoxylated pentaerythritol, polyvinyl alcohol, sorbitol, ethylene carbonate, propylene carbonate, and combinations comprising at least one of the foregoing.

Additional surface crosslinkers include a borate, titanate, zirconate, aluminate, chromate, or a combination comprising at least one of the foregoing. Boron crosslinkers include boric acid, sodium tetraborate, encapsulated borates, and the like. Borate crosslinkers can be used with buffers and pH control agents including sodium hydroxide, magnesium oxide, sodium sesquicarbonate, and sodium carbonate, amines (such as hydroxyalkyl amines, anilines, pyridines, pyrimidines, quinolines, pyrrolidines, and carboxylates such as acetates and oxalates), delay agents including sorbitol, aldehydes, sodium gluconate, and the like. Zirconium crosslinkers, e.g., zirconium lactates (e.g., sodium zirconium lactate), triethanolamines, 2,2′-iminodiethanol, or a combination comprising at least one of the foregoing can be used. Titanate crosslinkers can include, for example, lactates, triethanolamines, and the like.

The superabsorbent polymer can include repeat units comprising an acrylate, an acrylamide, a vinylpyrrolidone, a vinyl ester (e.g., vinyl acetate), a vinyl alcohol, an acrylic acid, a derivative thereof, or a combination comprising at least one of the foregoing. According to an embodiment, the superabsorbent polymer can comprise polyacrylamide having crosslinks derived from polyethylene glycol diacrylate. In some embodiments, the superabsorbent polymer comprises polyacrylic acid, wherein the crosslinks are derived from a vinyl ester oligomer. In another embodiment, the superabsorbent polymer is a poly(acrylic acid) partial sodium salt-graft-poly(ethylene glycol), which is commercially available from Sigma Aldrich.

The hydraulic fracturing diverter fluid further comprises an aqueous carrier fluid. The carrier fluid is included to carry the polymer particles to the desired location in the formation and to swell the polymer particles. The aqueous carrier fluid can be fresh water, brine (including seawater), an aqueous acid, for example a mineral acid or an organic acid, an aqueous base, or a combination comprising at least one of the foregoing. The brine can be, for example, seawater, produced water, completion brine, or a combination comprising at least one of the foregoing. The properties of the brine can depend on the identity and components of the brine. Seawater, for example, can contain numerous constituents including sulfate, bromine, and trace metals, beyond typical halide-containing salts. Produced water can be water extracted from a production reservoir (e.g., hydrocarbon reservoir) or produced from the ground. Produced water can also be referred to as reservoir brine and contain components including barium, strontium, and heavy metals. In addition to naturally occurring brines (e.g., seawater and produced water), completion brine can be synthesized from fresh water by addition of various salts for example, KCl, NaCl, ZnCl₂, MgCl₂, or CaCl₂ to increase the density of the brine, such as 10.6 pounds per gallon of CaCl₂ brine. Completion brines typically provide a hydrostatic pressure optimized to counter the reservoir pressures downhole. The above brines can be modified to include one or more additional salts. The additional salts included in the brine can be NaCl, KCl, NaBr, MgCl₂, CaCl₂, CaBr₂, ZnBr₂, NH₄Cl, sodium formate, cesium formate, and combinations comprising at least one of the foregoing. The salt can be present in the brine in an amount of about 0.5 to about 50 weight percent (wt. %), specifically about 1 to about 40 wt. %, and more specifically about 1 to about 25 wt. %, based on the weight of the fluid.

The aqueous carrier fluid can be an aqueous mineral acid such as hydrochloric acid, nitric acid, phosphoric acid, sulfuric acid, boric acid, hydrofluoric acid, hydrobromic acid, perchloric acid, or a combination comprising at least one of the foregoing. The fluid can be an aqueous organic acid that includes a carboxylic acid, sulfonic acid, or a combination comprising at least one of the foregoing. Exemplary carboxylic acids include formic acid, acetic acid, chloroacetic acid, dichloroacetic acid, trichloroacetic acid, trifluoroacetic acid, propionic acid, butyric acid, oxalic acid, benzoic acid, phthalic acid (including ortho-, meta- and para-isomers), and the like. Exemplary sulfonic acids include a C₁₋₂₀ alkyl sulfonic acid, wherein the alkyl group can be branched or unbranched and can be substituted or unsubstituted, or a C₃₋₂₀ aryl sulfonic acid wherein the aryl group can be monocyclic or polycyclic, and optionally comprises 1 to 3 heteroatoms (e.g., N, S, or P). Alkyl sulfonic acids can include, for example, methane sulfonic acid. Aryl sulfonic acids include, for example, benzene sulfonic acid or toluene sulfonic acid. In some embodiments, the aryl group can be C₁₋₂₀ alkyl-substituted, i.e., an alkylarylene group, or is attached to the sulfonic acid moiety via a C₁₋₂₀ alkylene group (i.e., an arylalkylene group), wherein the alkyl or alkylene can be substituted or unsubstituted.

Once the polymer particles are combined with the aqueous carrier fluid, the particles expand to a swelled state while maintaining their shape. Particles in the swelled state can have an average diameter of 1 to 1000 times greater than that of the same polymer particles that have not been exposed to an aqueous fluid. The polymer particles can expand to an expanded state in 5 minutes to 36 hours following contacting the particles with an aqueous fluid, for example, the carrier fluid. In some embodiments, particularly where the polymer particles can be used in diversion in deep fracture zones, the polymer particles can expand to an expanded state in 1 to 36 hours, specifically, 1 to 24 hours, more specifically, 1 to 12 hours following contacting the particles with an aqueous fluid, for example, the carrier fluid. In some embodiments, the polymer particles can expand to an expanded state in 5 to 60 minutes, specifically, 10 to 30 minutes, more specifically, 15 to 25 minutes, following contacting the particles with an aqueous fluid, for example, the carrier fluid.

The aqueous carrier fluid can be selected depending on the desired timing of the swelling of the particles, and/or depending on the desired downhole placement of the particles. Controlling the downhole placement of the particles can further control the diversion location within the formation. In some embodiments, the viscosity of the carrier fluid controls the timing of the swelling of the particles. For example, the aqueous carrier fluid can be slickwater (e.g., having a viscosity of about 1 cP) and the polymer particles can expand to a swelled state in 5 to 60 minutes, specifically, 15 to 30 minutes, following contacting the particles with the slickwater.

Alternatively, increasing the viscosity of the carrier fluid can inhibit the swelling of the particles, and thus the particles expand to a swelled state over a longer period of time, for example 1 to 36 hours, specifically, 6 to 24 hours, more specifically, 12 to 24 hours following contacting the particles with the carrier fluid. For example, the viscosity of the diverter fluid can be adjusted from about 0.0001 cP to about 1010 cP, specifically about 1 cP to about 1000 cP to obtain the foregoing swelling times. For example, the aqueous carrier fluid can be a gelled fluid having a viscosity of about 500 cP and the polymer particles can expand to a swelled state in 1 to 12 hours, specifically, 4 to 8 hours.

The viscosity of the diverter fluid can be modified by changing the salinity of the fluid, changing the pH of the fluid, or increasing the amount of water present in the fluid.

In addition to the polymer particles, the diverter fluid can further comprise a plurality of lightweight, friction-enhancing particulates. As used herein, “lightweight particulates” enhance friction between the particles, are substantially neutrally buoyant in the carrier fluid, or have an apparent specific gravity (ASG) less than or equal to 3.25, less than or equal to 2.25, more preferably less than or equal to 2.0, even more preferably less than or equal to 1.75, most preferably less than or equal to 1.25 and often less than or equal to 1.05. The lightweight particulates can be any material known for use as a proppant, such as bauxite, ceramic proppant, sand, resin-coated sand, and an ultra-lightweight proppant that have a specific gravity less than 2.40. In an embodiment, the lightweight particulates are sand. In another embodiment, the lightweight particulates are LiteProp™ proppants, available from Baker Hughes Incorporated.

The diverter fluid can optionally further comprise other components, for example additional diverters that are not the same as the water-swellable polymer particles. The additional diverters can be a dissolvable particulate diverter, which can include, for example, phthalic anhydride, polylactic acid, phthalic acid, rock salt, benzoic acid flakes, ground-up dissolvable ballsealers comprising collagen, ester-containing compounds, sodium chloride grains, polyglycolic acid, and the like. When present, the additional diverter can be present in a concentration of 0.1 to 200 pounds per thousand gallons, specifically, 0.5 to 60 pounds per thousand gallons, more specifically, 1 to 40 pounds per thousand gallons. In a specific embodiment, the diverter fluid can comprise the carrier, the water-swellable polymer particles, a lightweight particulate (e.g., LiteProp™ or sand), and a dissolvable particulate diverter (e.g., phthalic anhydride).

The diverter fluid can optionally include a breaker effective to break the polymer particles. The term “breaking” refers to disintegrating, decomposing, or dissociating the polymer particles, for example, by breaking bonds in the backbone of the polymer, breaking crosslinks, changing a geometrical conformation of the polymer, or a combination comprising at least one of the foregoing. In this way, the polymer particles leave minimum formation or proppant damage. In some embodiments, the breaker breaks the superabsorbent polymer to form a decomposed polymer, for example, a plurality of fragments that have a lower molecular weight or smaller size than the polymer of the polymer particle.

The breaker can include an oxidizer such as a peroxide (e.g., hydrogen peroxide, a metal peroxide, a superoxide, or an organic peroxide), a persulfate (e.g., a metal persulfate, ammonium persulfate, potassium peroxymonosulfate (Caro's acid)), a perphosphate, a perborate, a percarbonate, a persilicate, an oxyacid or oxyanion of a halogen (e.g., hypochlorous acid, a hypochlorite, chlorous acid, chlorites, chloric acid, chlorates, perchloric acid, and perchlorate), a peracid (e.g., a C₂₋₁₂ peroxycarboxylic acid, an ester thereof, a di(C₂₋₁₂ peroxycarboxylic acid), an ester thereof, or a sulfoperoxycarboxylic acid), or a combination comprising of any of the foregoing oxidizers.

The peroxide breaker can be a stabilized peroxide breaker with the hydrogen peroxide bound or inhibited by another compound or molecule prior to contact with, for example, an aqueous fluid such as water such that it forms or releases hydrogen peroxide when contacted by the aqueous fluid, for example, carbamide peroxide or urea peroxide (C(═O)(NH₂)₂.H₂O₂), a percarbonate (e.g., sodium percarbonate (2Na₂CO₃.3H₂O₂), potassium percarbonate, or ammonium percarbonate. Stabilized peroxide breakers can also include compounds that undergo hydrolysis in water to release hydrogen peroxide, e.g., sodium perborate. For example, hydrogen peroxide stabilized with appropriate surfactants also can be used as the stabilized peroxide breaker.

Peracids have the general formula R(CO₃H)ₙ wherein n is 1, 2, or 3, and R can be a saturated or unsaturated, substituted or unsubstituted hydrocarbyl group. For example, R can be C₁₋₁₂ alkyl, C₂₋₁₂ alkenyl, C₇₋₁₀ arylalkyl, C₇₋₁₀ arylalkenyl, C₃₋₈ cycloalkyl, C₂₋₁₂ cycloalkenyl, C₂₋₁₂ aryl, C₃₋₁₂ heterocyclic, an ester group of the formula R¹OC(═O)R²— where R¹ and R² are independently C₁₋₈ alkyl, C₁₋₈ alkenyl, C₁₋₈ arylalkyl, C₁₋₈ arylalkenyl, C₁₋₈ cycloalkyl, C₁₋₈ cycloalkenyl, C₁₋₈ aromatic, C₁₋₈ heterocyclic, preferably a C₁-C₅ alkyl group, or a sulfonated group of the formula R³CH(SO₃X)R⁴— wherein R³ is hydrogen or a saturated or unsaturated, substituted or unsubstituted hydrocarbyl group, preferably C₁₋₁₂ alkyl, C₂₋₁₂ alkenyl, C₇₋₁₀ arylalkyl, C₇₋₁₀ arylalkenyl, C₃₋₈ cycloalkyl, C₂₋₁₂ cycloalkenyl, C₂₋₁₂ aryl, or C₃₋₁₂ heterocyclic, R⁴ is a substituted or unsubstituted C₁₋₁₀ alkylene group, and X is hydrogen, a cationic group, or an ester forming moiety.

For example, the peracid can be peroxybenzoic acid, peroxyformic acid, peroxyacetic acid, peroxypropionic acid, peroxybutanoic acid, peroxypentanoic acid, peroxyhexanoic acid, peroxyheptanoic acid, peroxyoctanoic acid, peroxynonanoic acid, peroxydecanoic acid, peroxyundecanoic acid, peroxydodecanoic acid, peroxylactic acid, peroxycitric acid, peroxymaleic acid, peroxyascorbic acid, peroxyhydroxyacetic (peroxyglycolic) acid, peroxyoxalic acid, peroxymalonic acid, peroxysuccinic acid, peroxyglutaric acid, peroxyadipic acid, peroxypimelic acid, peroxysuberic acid, peroxysebacic acid, or a combination comprising at least one of the foregoing. In an embodiment, the peroxycarboxylic acid includes peroxyacetic acid (POAA, having the formula CH₃COOOH) or peroxyoctanoic acid (POOA, e.g., having the formula CH₃(CH₂)₆COOOH). Exemplary alkyl esterperoxycarboxylic acids include monomethyl monoperoxyglutaric acid, monomethyl monoperoxyadipic acid, monomethyl monoperoxyoxalie acid, monomethyl monoperoxymalonic acid, monomethyl monoperoxysuccinic acid, monomethyl monoperoxypimelic acid, monomethyl monoperoxysuberic acid, and monomethyl monoperoxysebacic acid; mono ethyl monoperoxyoxalic acid, monoethyl monoperoxymalonic acid, monoethyl monoperoxysuccinic acid, monoethyl monoperoxyglutaric acid, monoethyl monoperoxyadipic acid, monoethyl monoperoxypimelic acid, monoethyl monoperoxysuberic acid, and monoethyl monoperoxysebacic acid; monopropyl monoperoxyoxalic acid, monopropyl monoperoxymalonic acid, monopropyl monoperoxysuccinic acid, monopropyl monoperoxyglutaric acid, monopropyl monoperoxyadipic acid, monopropyl monoperoxypimelic acid, monopropyl monoperoxysuberic acid, monopropyl monoperoxysebacic acid, in which propyl is n- or isopropyl; monobutyl monoperoxyoxalic acid, monobutyl monoperoxymalonic acid, monobutyl monoperoxysuccinic acid, monobutyl monoperoxyglutaric acid, monobutyl monoperoxyadipic acid, monobutyl monoperoxypimelic acid, monobutyl monoperoxysuberic acid, monobutyl monoperoxysebacic acid, in which butyl is n-, iso-, or t-butyl, and the like.

Sulfoperoxycarboxylic acids, which also are referred to as sulfonated peracids, include the peroxycarboxylic acid form of a sulfonated carboxylic acid.

The breaker can be encapsulated in an encapsulating material to prevent the breaker from contacting the polymer particles. The encapsulating material can be configured to release the breaker in response to a breaker condition. The breaker can be a solid or a liquid. As a solid, the breaker can be, for example, a crystalline or a granular material. In an embodiment, the solid can be encapsulated or provided with a coating to delay its release or contact with the superabsorbent polymer. Encapsulating materials can be the same or different as the coating materials noted above with regard to the proppants. Methods of disposing the encapsulating material on the breaker can be the same or different as those for disposing the coating on the proppant particles. In another embodiment, a liquid breaker can be dissolved in an aqueous solution or another suitable solvent.

The encapsulation material can be a polymer that releases the breaker in a controllable way, for example, at a controlled rate or concentration. Such a polymer can degrade over a period of time to release the breaker and is chosen depending on the release rate desired. Degradation of the encapsulation material polymer can occur, for example, by hydrolysis, solvolysis, melting, and the like. The polymer of the encapsulation material can be, for example, a homopolymer or copolymer of glycolate and lactate, a polycarbonate, a polyanhydride, a polyorthoester, a polyphosphazene, or a combination comprising at least one of the foregoing.

The encapsulated breaker can be an encapsulated hydrogen peroxide, encapsulated metal peroxide (e.g., sodium peroxide, calcium peroxide, zinc peroxide, and the like) or any of the peracids or other breaker described herein.

The breaker can be present in the diverter fluid in an amount of 0 to 20 parts per thousand (ppt), specifically 0 to 15 ppt, and more specifically, 0 to 10 ppt, based on the total weight of the diverter fluid.

A proppant can optionally further be included in the diverter fluid, in an amount of about 0.01 to about 20, preferably about 0.1 to about 12 weight percent (wt. %) based on the total weight of the diverter fluid. Suitable proppants are known in the art and can be a relatively lightweight or substantially neutrally buoyant particulate material or a mixture comprising at least one of the foregoing. Such proppants can be chipped, ground, crushed, or otherwise processed. By “relatively lightweight” it is meant that the proppant has an apparent specific gravity (ASG) that is substantially less than a conventional proppant employed in hydraulic fracturing operations, for example, sand or having an ASG similar to these materials. Especially preferred are those proppants having an ASG less than or equal to 3.25. Even more preferred are ultra-lightweight proppants having an ASG less than or equal to 2.40, more preferably less than or equal to 2.0, even more preferably less than or equal to 1.75, most preferably less than or equal to 1.25 and often less than or equal to 1.05.

The proppant can comprise sand, glass beads, walnut hulls, metal shot, resin-coated sands, intermediate strength ceramics, sintered bauxite, resin-coated ceramic proppants, plastic beads, polystyrene beads, thermoplastic particulates, thermoplastic resins, thermoplastic composites, thermoplastic aggregates containing a binder, synthetic organic particles including nylon pellets and ceramics, ground or crushed shells of nuts, resin-coated ground or crushed shells of nuts, ground or crushed seed shells, resin-coated ground or crushed seed shells, processed wood materials, porous particulate materials, and combinations comprising at least one of the foregoing. Ground or crushed shells of nuts can comprise shells of pecan, almond, ivory nut, brazil nut, macademia nut, or combinations comprising at least one of the foregoing. Ground or crushed seed shells can include fruit pits, and can comprise seeds of fruits including plum, peach, cherry, apricot, and combinations comprising at least one of the foregoing. Ground or crushed seed shells can further comprise seed shells of other plants including maize, for example corn cobs and corn kernels. Processed wood materials can comprise those derived from woods including oak, hickory, walnut, poplar, and mahogany, and includes such woods that have been processed by any means that is generally known including grinding, chipping, or other forms of particulization. A porous particulate material can be any porous ceramic or porous organic polymeric material, and can be natural or synthetic. The porous particulate material can further be treated with a coating material, a penetrating material, or modified by glazing.

The proppant can be coated, for example, with a resin. Individual proppant particles can have a coating applied thereto. If the proppant particles are compressed during or subsequent to, for example, fracturing, at a pressure great enough to produce fine particles therefrom, the fine particles remain consolidated within the coating so they are not released into the formation. It is contemplated that fine particles decrease conduction of hydrocarbons (or other fluid) through fractures or pores in the fractures and are avoided by coating the proppant. Coatings for the proppant can include cured, partially cured, or uncured coatings of, for example, a thermosetting or thermoplastic polymer. Curing the coating on the proppant can occur before or after disposal of the hydraulic fracturing fluid downhole, for example.

The coating can be an organic compound such as epoxy, phenolic, polyurethane, polycarbodiimide, polyamide, polyamide imide, furan resins, or a combination comprising at least one of the foregoing; a thermoplastic resin such as polyethylene, acrylonitrile-butadiene styrene, polystyrene, polyvinyl chloride, fluoropolymers, polysulfide, polypropylene, styrene acrylonitrile, nylon, and phenylene oxide; or a thermoset resin such as epoxy, phenolic (a true thermosetting resin such as resole or a thermoplastic resin that is rendered thermosetting by a hardening agent), polyester, polyurethane, and epoxy-modified phenolic resin. The coating can be a combination comprising at least one of the foregoing.

A curing agent for the coating can be amines and their derivatives, carboxylic acid terminated polyesters, anhydrides, phenol-formaldehyde resins, amino-formaldehyde resins, phenol, bisphenol A and cresol novolacs, phenolic-terminated epoxy resins, polysulfides, polymercaptans, and catalytic curing agents such as tertiary amines, Lewis acids, Lewis bases, or a combination comprising at least one of the foregoing.

The proppant can include a crosslinked coating. The crosslinked coating can provide crush strength, or resistance, for the proppant and prevent agglomeration of the proppant even under high pressure and temperature conditions. The proppant can have a curable coating, which cures subsurface, for example, downhole or in a fracture. The curable coating can cure under the high pressure and temperature conditions in the subsurface reservoir. Thus, the proppant having the curable coating can be used for high pressure and temperature conditions.

The coating can be disposed on the proppant by mixing in a vessel, for example, a reactor. Individual components including the proppant and resin materials (e.g., reactive monomers used to form, e.g., an epoxy or polyamide coating) can be combined in the vessel to form a reaction mixture and agitated to mix the components. Further, the reaction mixture can be heated at a temperature or at a pressure commensurate with forming the coating. The coating can be disposed on the particle via spraying for example by contacting the proppant with a spray of the coating material. The coated proppant can be heated to induce crosslinking of the coating.

The term “substantially neutrally buoyant” refers to the proppant having an ASG close to the ASG of an ungelled or weakly gelled carrier fluid (e.g., ungelled or weakly gelled completion brine, other aqueous-based fluid, or other suitable fluid) to allow pumping and satisfactory placement of the proppant using the selected carrier fluid. For example, urethane resin-coated ground walnut hulls having an ASG of from about 1.25 to about 1.35 can be employed as a substantially neutrally buoyant proppant particulate in completion brine having an ASG of about 1.2. As used herein, a “weakly gelled” carrier fluid is a carrier fluid having minimum sufficient polymer, viscosifier or friction reducer to achieve friction reduction when pumped down hole (e.g., when pumped down tubing, work string, casing, coiled tubing, drill pipe, etc.), and/or can be characterized as having a polymer or viscosifier concentration of from greater than about 0 pounds of polymer per thousand gallons of carrier fluid to about 10 pounds of polymer per thousand gallons of carrier fluid, and/or as having a viscosity of about 1 to about 10 centipoise (cP). An ungelled carrier fluid can be characterized as comprising about 0 to less than 10 pounds of polymer per thousand gallons of carrier fluid. (If the ungelled carrier fluid is slickwater with a friction reducer, which can be a polyacrylamide, there can be 1 to as much as 8 pounds of polymer per thousand gallons of carrier fluid, but such minute concentrations of polyacrylamide do not impart sufficient viscosity (typically <3 cP) to be of benefit).

In some embodiments, the diverter fluid comprises the water-swellable polymer particles, the carrier fluid, a dissolvable particulate diverter (such as phthalic anhydride), and a proppant (such as LiteProp™ or sand). The foregoing composition can further comprise a breaker effective to break the polymer particles and/or a lightweight particulate.

The fluid of the diverter fluid can be foamed with a liquid hydrocarbon or a gas or liquefied gas such as nitrogen or carbon dioxide. The fluid can further be foamed by inclusion of a non-gaseous foaming agent. The non-gaseous foaming agent can be amphoteric, cationic, or anionic. Suitable amphoteric foaming agents include alkyl betaines, alkyl sultaines, and alkyl carboxylates. Suitable anionic foaming agents include alkyl ether sulfates, ethoxylated ether sulfates, phosphate esters, alkyl ether phosphates, ethoxylated alcohol phosphate esters, alkyl sulfates, and alpha olefin sulfonates. Suitable cationic foaming agents include alkyl quaternary ammonium salts, alkyl benzyl quaternary ammonium salts and alkyl amido amine quaternary ammonium salts. Foams are useful in fracturing low pressure or water sensitive formations.

The pH of the diverter fluid can be adjusted when desired. When adjusted, it can have a value of greater than or equal to about 6.5, or greater than or equal to 7, or greater than or equal to 8, or greater than or equal to 9, for example of about 9 to about 14, and preferably of about 7.5 to about 9.5. The pH can be adjusted by any means known in the art, including adding acid or base to the fluid, or bubbling carbon dioxide through the fluid.

The diverter fluid can be gelled or non-gelled. For example the fluid can be gelled by the inclusion of a viscosifying agent such as a viscosifying polymer, viscoelastic fluid, or foamed fluid. The fluid can optionally contain a crosslinking agent. The viscosity of the fluid can be greater than or equal to 10 cP at room temperature.

In a method of hydraulically fracturing a subterranean formation penetrated by a reservoir, a first stage comprises injecting, generally pumping, into the formation a fracturing fluid at a pressure sufficient to either propagate or enlarge a primary fracture. This fluid can be a pad fluid. Fracture conductivity can be improved by the incorporation of a proppant as described above in the hydraulic fracturing fluid. Typically, the amount of proppant in the fracturing fluid is about 0.01 to about 20, preferably about 0.1 to about 12, pounds of proppant added to a gallon of fracturing fluid to create a slurry comprising the proppant and the carrier fluid.

The diverter fluid comprising the polymer particles, and optionally lightweight particulates, can then be pumped directly to the high permeability zone of formation. Before substantial swelling of the polymer particles, the majority of the diverter fluid can enter into the high permeability or non-damaged zone and form a temporary “plug” or “viscous pill” while the lower permeability zone has little invasion. For example, the polymer particles can bridge fractures having widths smaller than the swelled particle size, thereby causing the particles to form the temporary plug and initiate an increase in the net pressure within the fracture. As the particles continue to swell, the viscous pill causes a further pressure increase and the breakdown pressure of another portion of the formation can be exceeded. When the breakdown pressure is exceeded, a new fracture begins to propagate and extend into the reservoir, increasing the fracture complexity. The fluid can also be diverted to a lower permeability portion of the formation as a result of the pressure increase, and further propagate existing fractures. Particles that swell more slowly are more capable of being spread deep into subterranean formations.

The viscous pill formed from the diverting agent can have a finite depth of invasion which is related to the pore throat diameter. For a given formation type, the invasion depth is directly proportional to the nominal pore throat diameter of the formation. Since varying depths of invasion occur throughout the formation based upon the varying permeability or damage throughout the treated zone, the ability of the treatment fluid to invade into pore throats is dependent on the difference between pore throat sizing of the damaged and non-damaged formation. Invasion depths can be greater in the cleaner or non-damaged portion of the formation (larger pore throats) than in the lower permeability or damaged zones (smaller or partially filled pore throats). With a greater depth of invasion in the cleaner sections of the formation, more of the diverter can be placed in these intervals.

After the plug or viscous pill has formed, which can be determined by monitoring a pressure difference in the formation after injecting the diverter fluid, additional fracturing fluid is introduced into the formation. The presence of the plug or viscous pill impedes the flow of the fracturing agent, thereby diverting it to other parts of the formation, whereby the surface area of the fracture is increased. Increased fracture surface area allows for improved hydrocarbon production from the formation.

In other embodiments, the various steps of the hydraulic fracturing methods described herein are premised on results obtained from monitoring of one or more operational parameters during treatment of the well. The methods can be used to extend fractures or create a multiple network of fractures. For example, the methods can be used to enhance the complexity of a fracture network within a subterranean formation and to enhance production of hydrocarbons from the formation. In the methods, one or more operational parameters of a hydraulic fracturing operation are monitored after completion of a fluid pumping stage. In particular, the operational parameters are compared to targeted parameters pre-determined by the operator. Based on the comparison, stress conditions in the well can be altered before introduction of a successive fluid stage into the formation.

The term “successive fluid pumping stage” as used herein refers to the fluid pumping stage in a hydraulic fracturing operation which precedes another fluid pumping stage. The fluid pumping stage which immediately precedes the successive fluid pumping stage is referred to as the “penultimate fluid pumping stage.” Since the methods described herein can be a continuous operation or have repetitive steps, a successive fluid pumping stage can be between two penultimate fluid pumping stages. For example, a first successive fluid pumping stage can follow a first penultimate fluid pumping stage. When referring to a “second successive fluid pumping stage,” the first successive fluid pumping stage is the second penultimate fluid pumping stage and so on. A successive fluid pumping stage can be pumped into the wellbore following a period of time for the fluid of the penultimate fluid pumping stage to be diverted into the fracture created or enlarged by the penultimate fluid pumping stage.

Stress within the well can be determined by monitoring one or more operational parameters. Changes in one or more of the operational parameters are indications to the operator that fracture complexity and/or fracture geometry has changed and that the total created fracture area has increased. For example, stress noted within the formation can be indicative as to propagation of the fracture. The method of assessing stress within the well can include real-time modeling of the created fracture network using a simulator, such as MShale.

Thus, observance of trends and responses of operational parameters resulting from a penultimate fluid pumping stage can be used to control and dictate conditions of successive fluid pumping stage.

For example, variances between one or more pre-determined operational parameters with the operational parameter after a second successive fluid pumping stage can indicate to the operator whether new fractures have been created or whether fluid has been likely used to increase the fracture width of preexisting fractures during the second penultimate fluid pumping stage to intercepting fractures.

Based upon the change in one or more of the operational parameters, stress within the reservoir can be altered. For instance, where propagation is insufficient as determined by the operator after a fluid pumping stage, the operator can cause an alteration of the reservoir stress field. The methods defined herein can thus be used to increase the complexity of the fractures by artificially adding a resistance in the fracture such that new fracture paths are opened that would otherwise not be able to be created or enlarged. Thus, fracture complexity can be increased as the differential stress or propagation pressure increases. This can occur without a sustained increase in fracturing pressure.

One or more of the following operational parameters can be monitored during the fracturing operation: the rate of injection of the fluid, the bottomhole pressure of the well (measured as Net Pressure), and the density of the fluid pumped into the formation. Monitoring of the above operational parameter(s) can be used to create a network of fractures at near-wellbore as well as far-wellbore locations by altering stress conditions within the reservoir.

The rate of injection of the fluid is defined as the maximum rate of injection that the fluid can be pumped into the formation beyond which the fluid is no longer capable of fracturing the formation (at a given pressure). The maximum rate of injection is dependent on numerous constraints including the type of formation being fractured, the width of the fracture, the pressure at which the fluid is pumped, and permeability of the formation. The maximum rate of injection can be pre-determined by the operator. Changes in Net Pressure are indications of change in fracture complexity and/or change in fracture geometry thus producing greater created fracture surface area within the formation. The Net Pressure that is observed during a hydraulic fracturing treatment is the difference between the fluid pressure in the fracture and the closure pressure (P_{closure}) of the formation. Fluid pressure in the fracture is equivalent to Bottom Hole Treating Pressure (BHTP). BHTP can be calculated from: Surface Treating Pressure (STP)+Hydrostatic Head (HH)−Total Delta Friction Pressures (Δp_{friction}=pipe friction+perforation friction+tortuosity).

Determination of closure pressure, pipe friction, perforation friction, and presence of tortuosity is critical. A diagnostic treatment using a step down rate and observance of pressure decline should be conducted if the formation can sustain a pumping shut down without limiting the desired injection rate upon restarting the injection to obtain these necessary parameters. The bottomhole pressure (also known as the measured or calculated bottomhole pumping pressure or measured or calculated bottomhole treating pressure) (BHP) is a measurement or calculation of the fluid pressure in a fracture. It is needed to determine the Net Pressure defined as:

Pₙₑₜ=STP+HH−P_{fric}−P_{closure}

Although many conventional fracture treatments result in bi-wing fractures, there are naturally fractured formations that provide the geomechanical conditions that enable hydraulically induced discrete fractures to be initiated and propagate in multiple planes as indicated by microseismic mapping. The dominant or primary fractures propagate in the x-z plane perpendicular to the minimum horizontal stress, σ₃. The y-z and x-y plane fractures propagate perpendicular to the σ₂ and σ₁, stresses, respectively. The discrete fractures created in the x-z and y-z planes are vertical, while the induced fractures created in the x-y plane are horizontal. The microseismic data collected during a fracture treatment can be a very useful diagnostic tool to calibrate the fracture model by inferring DFN areal extent, fracture height and half-length and fracture plan orientation. Integrating minifrac analysis, hydraulic fracturing and microseismic technologies with the production response for multiple transverse vertical fractures provides a methodology to improve the stimulation program for enhanced gas production.

Programs or models for modeling or predicting BHP are generally known. Examples of suitable models include, but are not limited to, “MACID” available from Baker Hughes Incorporated; “FRACPRO” from Resources Engineering Services; and “FRACPRO PT”, available from Pinnacle Technology. BHP can further be calculated based on formation characteristics. See, for instance, Hannah et al., “Real-time Calculation of Accurate Bottomhole Fracturing Pressure From Surface Measurements Using Measured Pressures as a Base”, SPE 12062 (1983); Jacot et al., “Technology Integration—A Methodology to Enhance Production and Maximize Economics in Horizontal Marcellus Shale Wells”, SPE 135262 (2010); and Yeager et al., “Injection/Fall-off Testing in the Marcellus Shale: Using Reservoir Knowledge to Improve Operational Efficiency”, SPE 139067 (2010).

The objective is therefore to observe changes in one or more of the operational parameters and alter the operational parameter(s) response using diversion. The value of that change will be formation and area specific and can even vary within the same formation, within the same lateral. Those differences arise in the varying minimum and maximum stress planes. In some instances there is very low anisotropy resulting in “net” fracture development. In other areas the anisotropy is very high and a conventional profile can dominate the fracture complexity.

Since the presence of low to high anisotropy, as well as anisotropy in between low anisotropy and high anisotropy, can often not be ascertained through a mini-frac treatment, net pressure changes are often the key operational parameter used to assess stress conditions. Downward (negative) slopes are indications of height growth while positive slopes of <45° will be indications of height and extension growth, depending on slope. Thus, changes in one or more of the operational parameters can be indicative of fracture height and growth. For example, while small changes in BHP can be due to varying frictional pressures of fluids (and proppants) as the fluid travels through the fracture system, sustained negative downward slopes can be indicative of height growth, and positive slopes of less than 45° can be indicative of height and extension growth.

Stress conditions in the well can be altered by diverter fluid flow such that the fluid pumped into the formation will more readily flow into less conductive secondary fractures within the formation. Diversion limits injectivity in the primary fractures and stress pressures within the formation. Accordingly, fluid flow can be diverted from a highly conductive primary fracture(s) to less conductive secondary fractures. Since conductivity is permeability multiplied by injection geometry, this is synonymous to the statement that fluid flow can be diverted from a high permeability zone to a low permeability zone. Further, since conductivity is a function of the relative resistance to inflow, the reference to a conductive fracture as used herein is considered synonymous to a conductive reservoir area. Alteration of the local stress conditions provides greater complexity to the created fracture network and/or improves the reservoir coverage of the stimulation treatment.

The methods described herein can be used to extend or increase a fracture profile. In addition, the methods described herein can be used to create a multiplicity of fractures originating from the original primary fracture wherein each successive stage creates a fracture having an orientation distinct from the directional orientation of the fracture created by the penultimate fracture.

Fluid flow can be diverted from highly conductive fractures to less conductive fractures by introduction of the diverter fluid or slug containing the polymer particles into the formation. This can cause displacement of the diverter slug beyond the near wellbore.

Further, a combination of the diverter fluid or slug can be used with a change in the injection rate and/or viscosity of fluid into the formation in order to effectuate diversion from a highly conductive fracture to a less conductive fracture. The diverter fluid can be pumped into the formation at a rate of injection which is different from the rate of injection of a penultimate fluid pumping stage but rate is necessarily limited to a rate low enough so as not to exceed the predetermined pressure limitations observed with the surface monitoring equipment.

The diversion stage serves to divert fluid flow away from highly conductive fractures and promote a change in fracture orientation. This causes fluid entry and extension into the secondary fractures. For example, a reduction in injection rate can be used to allow the shear thinning fluid to build sufficiently low shear rate viscosity for adequate pressure diversion for the changing fracture orientation created by the secondary fractures. In addition, reduction in injection rate can contribute to the opening and connecting of secondary fractures.

The diverter fluid and the optional change in injection rate of pumped fluid can create at least one secondary fracture in a directional orientation distinct from the directional orientation of the primary fracture. Thus, at some point along the primary fracture, the resistance to flow of the viscosity and resultant increased pressure induces the successive stage fluid to be diverted to a new area of the reservoir such that an increase in created fracture area occurs.

After diversion, the flow of fluid introduced into the low permeability zone of the formation can be impeded. The operational parameter being monitored can then be compared to the pre-determined operational parameter. Subsequent fluid stages can be introduced into the formation and the need for diversionary stages will be premised on the difference between the monitored operational parameter following the subsequent fluid stage with the targeted operational parameter.

After the diverter fluid is pumped and/or after the injection rate of fluid into the formation is modified, the operational parameter being monitored can then be noted. If the operational parameter is less than the target of the operational parameter, the fluid flow can continue to be diverted in another diversionary step.

The process can be repeated until the total created fracture area desired is obtained or until the complexity of the fracture is attained which maximizes the production of hydrocarbons from the formation.

Thus, by monitoring an operational parameter and observing changes in the operational parameter, stresses within the formation can be altered. The value of any diversionary step will be formation and area specific and differences can be noted in varying minimum and maximum stress planes within the same lateral. For example, in some instances very low anisotropy will result in net fracture development. In other areas, very high anisotropy can dominate the fracture complexity.

For example, the bottomhole pressure of fluid after pumping a first stage can be compared to the targeted pre-determined bottomhole pressure of the well. The first stage can be the stage which enlarges or creates a fracture. Based on the difference in the bottomhole pressure, the flow of fluid from a highly conductive primary fracture to less conductive secondary fractures can be diverted by injecting into the formation the diverter fluid comprising water-swellable polymer particles. The bottomhole pressure after diversion can then be compared to the pre-determined bottomhole pressure. The flow of fluid introduced into the low conductive fracture in the next stage can then be impeded. Subsequent fluid stages can be introduced into the formation and the need for subsequent diversionary stages will be premised on the difference between the bottomhole pressure after a preceding stage and the pre-determined bottomhole pressure.

In another embodiment, the maximum injection rate which a fluid can be pumped after the pumping of a first fluid stage can be compared to the targeted injection rate. The first stage can be the stage which enlarges or creates a fracture. Based on the difference in the rates of injection, the flow of fluid from a highly conductive primary fracture to less conductive secondary fractures can be diverted by injecting into the formation the diverter fluid comprising water-swellable polymer particles. The maximum rate of injection after the diversion can then be compared to the pre-determined rate of injection. The flow of fluid introduced into the low conductive fracture in the next stage can then be impeded. Subsequent fluid stages can be introduced into the formation and the need for subsequent diversionary stages will be premised on the difference between the maximum rate of injection after a preceding stage and the pre-determined injection rate.

In another embodiment, the density of a fluid stage after pumping a first stage can be compared to a targeted density of a fluid stage. Based on the difference in fluid density, the flow of fluid from a highly conductive primary fracture to less conductive secondary fractures can be diverted by injecting into the formation the diverter fluid comprising water-swellable polymer particles. The density of the fluid stage after the diversion can then be compared to the pre-determined fluid density. The flow of fluid introduced into the low conductive fracture in the next stage can then be impeded. Subsequent fluid stages can be introduced into the formation and the need for subsequent diversionary stages will be premised on the difference between the fluid stage density after a preceding stage and the pre-determined fluid density.

The diversion stage can be pumped into the formation after the first stage or between any of the successive stages or penultimate stages.

Between any penultimate stage and successive stage, pumping can be stopped and a fluid containing a proppant can be pumped into the reservoir to assist in the creation or enlargement of secondary fractures. Suitable proppants are described above.

An exemplary process defined herein can monitor Net Pressure as the operational parameter and the fluid volume of each of the stages can be set by an operator; the total volume of the fluid being broken into four or more stages. Each stage can be separated by a period of reduced or suspended pumping for a sufficient duration to allow the staged fluid in the reservoir to flow into a created or enlarged fracture.

The injection rate and the STP can be established by the operator. The fracturing operation is initialized by pumping into the formation a first fluid stage comprising a pad fluid or slickwater. The Net Pressure response of the treatment is monitored. A plot of Net Pressure verses time on a log-log scale can be used to identify trends during the treatment. At the end of the fluid pumping stage, the net pressure value and slope is evaluated.

Where the pressure is greater than or equal to the pre-determined BHP, then additional fracturing fluid can be pumped into the formation as a second or successive stage and it is not necessary to divert the flow of fluid from a high permeability zone to a lower permeability zone. Where the BHP (as measured by net Pressure) is less than the pre-determined BHP, then a diverter fluid containing a diverting agent can be pumped into the formation. The diverting agent can be displaced beyond near wellbore. The diverter fluid can be over-displaced beyond the wellbore and into the fracture network. The net pressure response is then observed when the diversion stage is beyond the wellbore and in the fracture network. If the net pressure response is considered to be significant by the operator indicating a change in fracture complexity and/or geometry then an additional fracturing fluid can be pumped into the formation in order to stimulate a larger portion of the reservoir. At the end of pumping stage, net pressure can again be evaluated and the possibility of running another diversion stage can be evaluated. If the net pressure response is not considered to be significant by the operator, then an additional diversion stage can be pumped into the formation and the net pressure response is evaluated when the diversion stage is beyond the wellbore and in the fracture network. The volume and quantity of the successive diversion stage can be the same as the penultimate diversion stage or can be varied based on the pressure response. The injection rate of the pumped fluid can also be changed once the diversion stage is in the fracture system to affect the pressure response. If the net pressure response is too significant in size indicating a bridging of the fracture without a change in fracture complexity and/or geometry, additional pumping may or may not be warranted. For example, if the pressure response is too high, the pressure limitations of the tubulars can prevent a continuation of the treatment due to rate and formation injectivity limitations. The running of additional diversion stages can be repeated as necessary until a desired pressure response is achieved and the fracture complexity/geometry is maximized, the well treatment injection is ceased and the well can then be shut in, flowed back or steps can be undertaken to complete subsequent intervals.

If the BHP is less than the pre-determined BHP, then a successive stage can be pumped into the formation and the process repeated. The process can be continuous and can be repeated multiple times throughout the course of the pumping treatment to attain development of a greater fracture area and greater fracture complexity than that which would be attained in the absence of such measures.

The diversion stage either achieves or directly impacts the monitored BHP so as to artificially increase the differential pressure. This differential pressure cannot be obtained without the diverter fluid. The increased pressure differential causes sufficient stress differential to create or enlarge a smaller fracture. The effectiveness of the diversion stage can then be ascertained by either increasing the concentration of a diverting agent or the size of the diverting agent. The increase in BHP from the diversion stage limits the fluid volume introduced into the formation which would otherwise be larger volume. Thus, a benefit of the process is that a decreased amount of water can be used to achieve a given degree of stimulation.

In place of the BHP, other parameters, such as fluid density and injection rate of the fluid, can be used as the operational parameter. With any of these parameters, the operator will determine the targeted level based on the characteristics of the well and formation being treated. Reduction of the injection rate of the fluid further can facilitate the diversion of flow from narrow intersecting fractures especially when accompanied by increases in the treating pressure. An increase in the injection rate of the fluid renders greater propagation in the more primary fractures within the formation.

The methods described herein can be used in the fracturing of formations penetrated by horizontal and vertical wellbores. The polymer particles can be particularly effective when placed into wells having bottomhole temperatures of about 20° C. to about 250° C.

The formation subjected to the treatment of the invention can be a hydrocarbon or a non-hydrocarbon subterranean formation. The high permeability zone of the formation into which the fluid containing the diverting agent is pumped can be natural fractures. The particles can be capable of diverting fracturing fluids to extend fractures and increase the stimulated surface area.

Hydrocarbon-bearing formations that can benefit from the method of the present disclosure include carbonate formations, for example limestone, chalk or dolomite as well as subterranean sandstone or siliceous formations in oil and gas wells, for example quartz, clay, shale, silt, chert, zeolite, or a combination comprising at least one of the foregoing.

The method can further be used in the treatment of coal beds having a series of natural fractures, or cleats, for the recovery of natural gases, such as methane, and/or sequestering a fluid which is more strongly adsorbing than methane, such as carbon dioxide and/or hydrogen sulfide.

The diverter fluid composition and method of use provided herein has advantageous properties including using polymer particles to effectively bridge fractures in hydrocarbon-bearing formations, and divert fluid flow into secondary fractures, thereby increasing the hydraulic fracture network. The inclusion of proppants in the diverter fluid can further enhance the bridging and diverting effects achieved by the polymer particles alone.

### EXAMPLES

The following experimental apparatus was used to assess various diverter fluid compositions in the following Examples. The apparatus is composed of stainless steel tubing having an inner diameter of about 4.8 millimeters. The apparatus has two fluid containers holding the diverter fluid, which is injected through two separate lines. A third line injects only water. The three inlet lines meet at one point that is connected to a pressure gauge to measure the injection pressure of the injected fluids. At this intersection, the lines are divided into two paths. The first path has a length of 20 feet, and a pressure gauge at the end to measure the flowing pressure. This path also has a relief valve that opens when pressures greater than 150 psi are reached. This first path is the path having the least resistance. The second path has a length of 1 foot, and a pressure gauge at the end to measure the flowing pressure. This path has a relief valve that opens when pressures greater than 1500 psi are reached. This second path is the path having the highest resistance. When a fluid effective as a diverter fluid is used, fluid will only flow through the second path (highest resistance), with no flow through the first path (least resistance).

### Example 1

Example 1 is a Comparative Example demonstrating use of a high viscosity fluid to form a viscous pill to achieve diversion. The high viscosity fluid was prepared as follows. Guar, obtained as GW-24 from Baker Hughes Incorporated, was crosslinked using a borate crosslinker, obtained as XLW-57 from Baker Hughes Incorporated, in fresh water to make a 5 gallons per thousand gallons (gpt) fluid. The high viscosity fluid was added to each of the two fluid containers in the setup described above, and injected into the system. During the flow of this high viscosity material, the injection and the second path pressure gauge read 850 psi. The first path pressure gauge read 150 psi. All fluid flowed through the first path (path having least resistance). A pressure of 700 psi was built up over a length of 20 feet. Example 1 illustrates the deficiencies of a high viscosity fluid viscous pill when used as a diverter fluid.

### Example 2

Example 2 is an inventive Example demonstrating the use of water-swellable polymer particles to achieve diversion. Commercially available superabsorbent polymer particles were added to 50 milliliters of water to produce superabsorbent polymer particles having an average diameter of about 2 millimeters. The diverter fluid was prepared by adding the above described polymer particles to water. Polymer particles having an initial diameter of about 2 millimeters could be expanded to give polymer particles having an expanded diameter of about 12 millimeters when exposed to the water for 6 hours. The increase in the volume of the beads represents the volume of water that was absorbed by the particles. In an experiment aimed at monitoring the water level during the particle expansion process confirmed a constant water level. Accordingly, the density of the particles is reduced during expansion.

As in Example 1, the diverter fluid of Example 2 was added to the fluid containers of the above described experimental setup. Upon injection into the system, it was noted that the number of particles affected the change in pressure recorded in the second path (highest resistance). Specifically, using more particles in the system resulted in an increased pressure drop. These results are summarized in Table 1. The results indicate that a higher concentration of particles can more effectively bridge the first path of least resistance, and divert the fluid flow to the second path having higher resistance.

TABLE 1

| Number of | ΔP (psi) in the second path |
|---|---|
| particles | (highest resistance) |
| 1 | 2 |
| 6 | 10 |
| 20 | 50 |
| 50 | 150 |
| 70 | 280 |

### Example 3

Example 3 is an inventive Example demonstrating the use of water-swellable polymer particles in combination with sand to achieve diversion. Commercially available superabsorbent polymer particles were added to 50 milliliters of water to produce water-swellable polymer particles having an average diameter of about 2 millimeters. The diverter fluid was prepared by adding the above described polymer particles to water. Polymer particles having an initial diameter of about 2 millimeters could be expanded to give polymer particles having an expanded diameter of about 12 millimeters when exposed to the water for 6 hours. Fluid containing the sand was first injected, followed by the diverter fluid containing the polymer particles. During the flow, the injection and the second path pressure gauge read 1500 psi. The first path pressure gauge read 0 psi. The flow of water was completely diverted from the first path to the second path. Thus, the combination of sand and polymer particles can create an enhanced diversion effect.

When water was injected in the opposite direction of the particles, the injection pressure increased to 300 psi, and the sand and the particles flowed out of the tube.

### Example 4

Example 4 is an inventive Example demonstrating the use of water-swellable polymer particles in combination with sand to achieve diversion. Commercially available superabsorbent polymer particles were added to 50 milliliters of water to produce a water-swellable polymer particle having an average diameter of about 2 millimeters. The diverter fluid was prepared by combining the polymer particles, sand, and water. Polymer particles having an initial diameter of about 2 millimeters could be expanded to give polymer particles having an expanded diameter of about 12 millimeters when exposed to the water for 6 hours. The diverter fluid containing the polymer particle and sand mixture was injected into the system. Upon injection, the injection and the second path pressure gauges read 1500 psi. The first path pressure gauge read 0 psi. The flow of water was completely diverted from the first path to the second path. Thus, the combination of sand and polymer particles can create an enhanced diversion effect.

The results of Examples 2 to 4 confirm that the use of water-swellable polymer particles comprising a superabsorbent polymer can effectively divert a fluid from a path having a lower resistance to a path having a higher resistance, for example, from a primary fracture to a secondary fracture. Without wishing to be bound by theory, it is believed that expanded polymer particles will have a relatively smooth surface that can contact the surface of the tube or the surface of the fracture. This can cause a relatively small amount of friction, and can affect the bridging and diverting capabilities of the beads when used alone. Further incorporating a proppant, for example sand, into the diverter fluid with the polymer particles can increase the roughness of the contacting surface, thereby increasing the friction and the created pressure. This is demonstrated by Examples 3 and 4, where a diverter fluid comprising sand more effectively diverts the fluid flow to the path having higher resistance.

The diverter fluids and methods disclosed herein are further illustrated by the following embodiments, which are non-limiting.

### Embodiment 1

A diverter fluid, comprising an aqueous carrier fluid; and a plurality of water-swellable polymer particles having a size of 0.01 to 100,000 micrometers, preferably 1 to 10,000 micrometers, more preferably 50 to 5,000 micrometers.

### Embodiment 2

The diverter fluid of embodiment 1, wherein the polymer particles are swellable to an average diameter of 1.1 to 1000 times greater than that of the same polymer particles that have not been swelled.

### Embodiment 3

The diverter fluid of embodiments 1 or 2, wherein the polymer particles are fully swelled after contacting the aqueous diverter carrier fluid for 5 to 60 minutes, preferably 15 to 30 minutes.

### Embodiment 4

The diverter fluid of embodiments 1 or 2, wherein the polymer particles are fully swelled after contacting the aqueous diverter carrier fluid for 1 to 36 hours, preferably 6 to 36 hours, more preferably 12 to 24 hours.

### Embodiment 5

The diverter fluid of any one or more of embodiments 1 to 4, wherein the polymer particles are present in the diverter fluid in a concentration of 0.1 to 200 pounds per thousand gallons, preferably 0.5 to 60 pounds per thousand gallons, more preferably 1 to 40 pounds per thousand gallons.

### Embodiment 6

The diverter fluid of any one or more of embodiments 1 to 5, wherein the polymer particles comprise a polysaccharide, poly(hydroxyC₁₋₈ alkyl (meth)acrylate)s such as poly(2-hydroxyethyl acrylate), poly(C₁₋₈ alkyl (meth)acrylate)s, poly((meth)acrylamide)s, poly(vinyl pyrrolidine), poly(vinyl acetate), or a combination comprising at least one of the foregoing, preferably a polyacrylic acid.

### Embodiment 7

The diverter fluid of any one or more of embodiments 1 to 6, wherein the diverter carrier fluid comprises fresh water, brine, aqueous acid, aqueous base, or a combination comprising at least one of the foregoing.

### Embodiment 8

The diverter fluid of any one or more of embodiments 1 to 7, wherein the diverter fluid further comprises a lightweight particulate different from the water-swellable polymer particles, preferably sand.

### Embodiment 9

The diverter fluid of embodiment 8, wherein the lightweight particulate has an apparent specific gravity of less than or equal to 3.25.

### Embodiment 10

The diverter fluid of any one or more of embodiments 1 to 9, wherein the diverter fluid further comprises an oxidative breaker.

### Embodiment 11

The diverter fluid of any one or more of embodiments 1 to 10, wherein the diverter fluid further comprises an additional diverter different from the water-swellable polymer particles, preferably phthalic anhydride, polylactic acid, phthalic acid, rock salt, benzoic acid flakes, ground-up dissolvable ballsealers comprising collagen, ester-containing compounds, sodium chloride grains, polyglycolic acid, and combinations comprising at least one of the foregoing.

### Embodiment 12

The diverter fluid of any one or more of embodiments 1 to 11, wherein the diverter fluid further comprises one or more of: a lightweight particulate different from the water-swellable polymer particles, wherein the lightweight particulate has an apparent specific gravity of less than or equal to 3.25; an oxidative breaker; and an additional diverter different from the water-swellable polymer particles, preferably phthalic anhydride, polylactic acid, phthalic acid, rock salt, benzoic acid flakes, ground-up dissolvable ballsealers comprising collagen, ester-containing compounds, sodium chloride grains, polyglycolic acid, and combinations comprising at least one of the foregoing.

### Embodiment 13

A method of controlling the downhole placement of a diverting agent in a subterranean formation, the method comprising, injecting into the formation the diverter fluid of any one or more of embodiments 1 to 12; wherein the aqueous carrier fluid is selected so that the polymer particles are fully swelled after contacting the aqueous carrier fluid for an amount of time sufficient to achieve a desired downhole placement

### Embodiment 14

A method of controlling the downhole placement of a diverting agent in a subterranean formation, the method comprising, injecting into the formation a diverter fluid comprising the diverting agent comprising a plurality of water-swellable polymer particles having a size of 0.01 to 100,000 micrometers, preferably 1 to 10,000 micrometers, more preferably 50 to 5,000 micrometers; and an aqueous carrier fluid selected so that the polymer particles are fully swelled after contacting the aqueous carrier fluid for an amount of time sufficient to achieve a desired downhole placement.

### Embodiment 15

The method of embodiments 13 or 14, wherein the polymer particles are swellable to an average diameter of 1.1 to 1000 times greater than that of the same polymer particles that have not been swelled.

### Embodiment 16

The method of any one or more of embodiments 13 to 15, wherein the polymer particles are present in the diverter fluid in a concentration of 0.1 to 200 pounds per thousand gallons, preferably 0.5 to 60 pounds per thousand gallons, more preferably 1 to 40 pounds per thousand gallons.

### Embodiment 17

The method of any one or more of embodiments 13 to 16, wherein the polymer particles comprise a polysaccharide, poly(hydroxyC₁₋₈ alkyl (meth)acrylate)s such as poly(2-hydroxyethyl acrylate), poly(C₁₋₈ alkyl (meth)acrylate)s, poly((meth)acrylamide)s, poly(vinyl pyrrolidine), poly(vinyl acetate), or a combination comprising at least one of the foregoing, preferably a polyacrylic acid.

### Embodiment 18

The method of any one or more of embodiments 13 to 17 wherein the carrier fluid is a low viscosity fluid, preferably slickwater, freshwater, brine, aqueous acid, aqueous base, or a combination thereof; wherein the polymer particles are fully swelled after contacting the aqueous carrier fluid for 5 to 60 minutes, preferably 10 to 30 minutes, more preferably 15 to 25 minutes; and wherein the desired downhole placement is near wellbore.

### Embodiment 19

The method of any one or more of embodiments 13 to 18, wherein the carrier fluid is a high viscosity fluid, preferably a gelled fluid or a foam; wherein the polymer particles are fully swelled after contacting the aqueous carrier fluid for 1 to 36 hours, preferably 1 to 24 hours, more preferably 1 to 12 hours; and wherein the desired downhole placement is far field from a wellbore.

### Embodiment 20

The method of any one or more of embodiments 13 to 19, wherein the aqueous carrier fluid has a pH of 0 to 14 and the polymer particles are fully swelled after contacting the aqueous carrier fluid for 5 minutes to 36 hours.

### Embodiment 21

The method of any one or more of embodiments 13 to 20, wherein the diverter fluid further comprises a lightweight particulate different from the water-swellable polymer particles, preferably sand.

### Embodiment 22

The method of embodiment 21, wherein the lightweight particulate has an apparent specific gravity of less than or equal to 3.25.

### Embodiment 23

The method of any one or more of embodiments 13 to 22, wherein the diverter fluid further comprises an oxidative breaker.

### Embodiment 24

The method of any one or more of embodiments 13 to 23, wherein the diverter fluid further comprises an additional diverter different from the water-swellable polymer particles, preferably phthalic anhydride, polylactic acid, phthalic acid, rock salt, benzoic acid flakes, ground-up dissolvable ballsealers comprising collagen, ester-containing compounds, sodium chloride grains, polyglycolic acid, and combinations comprising at least one of the foregoing.

### Embodiment 25

The method of any one or more of embodiments 13 to 24, wherein the subterranean formation is a hydrocarbon-bearing formation.

### Embodiment 26

The method of any one or more of embodiments 13 to 25, wherein the subterranean formation is shale.

### Embodiment 27

A method of hydraulically fracturing a subterranean formation penetrated by a reservoir, the method comprising injecting a fracturing fluid into the formation at a pressure sufficient to create or enlarge a fracture; injecting the diverter fluid of any one or more of embodiments 1 to 12 into the formation; and injecting a fracturing fluid into the formation, wherein the flow of the fracturing fluid is impeded by the diverting agent and a surface fracture area of the fracture is increased.

### Embodiment 28

The method of embodiment 27, wherein the desired downhole placement of the diverting agent in the subterranean formation is achieved by the method of any one or more of embodiments 13 to 26.

### Embodiment 29

A method of hydraulically fracturing a subterranean formation penetrated by a reservoir, the method comprising injecting a fracturing fluid into the formation at a pressure sufficient to create or enlarge a primary fracture; determining a bottomhole treating pressure within the well; injecting into the formation the diverter fluid of any one or more of embodiments 1 to 12; comparing the determined bottomhole treating pressure with a pre-determined targeted bottomhole treating pressure; and injecting a fracturing fluid into the formation, wherein the flow of the fracturing fluid to the loss zone is impeded by the diverting agent and a surface fracture area is increased.

### Embodiment 30

The method of embodiment 29, further comprising injecting the diverter fluid at an injection rate that is different from the injection rate of the fracturing fluid.

### Embodiment 31

The method of any one or more of embodiments 29 to 30, wherein the diverting agent is removed subsequent to the increasing the fracture surface area in the formation.

### Embodiment 32

A method of hydraulically fracturing a subterranean formation penetrated by a well, the method comprising, injecting a fracturing fluid into the formation at a pressure sufficient to create or enlarge a fracture; determining a surface pressure at or near the surface of the well; injecting into the formation the diverter fluid of any one or more of embodiments 1 to 12 to divert a flow of fluid from a highly conductive zone to a less conductive; comparing the determined surface pressure with a targeted surface pressure; and altering a stress in the well to increase the surface area of the fracture, wherein altering is by varying an injection rate of the fracturing fluid, varying the bottomhole pressure of the well, varying the density of the fracturing fluid, or a combination comprising at least one of the foregoing.

### Embodiment 33

A method of hydraulically fracturing a subterranean formation penetrated by a well, the method comprising, injecting a fluid into the formation at a pressure sufficient to create or enlarge a primary fracture; monitoring an operational parameter and comparing the operational parameter after injecting of the fluid into the formation with a pre-determined value for the operational parameter, wherein the operational parameter is the injection rate of the fluid, the density of the fluid, and the bottomhole treating pressure of the well; injecting the diverter fluid of any one or more of embodiments 1 to 12 to divert the flow of fluid from a highly conductive zone to a less conductive zone; comparing the operational parameter injecting the diverter fluid with the pre-determined value for the operational parameter; altering a stress in the well to increase the surface area of the fracture, wherein altering is by varying an injection rate of the fracturing fluid, varying the bottomhole pressure of the well, varying the density of the fracturing fluid, or a combination comprising at least one of the foregoing.

### Embodiment 34

A method of hydraulically fracturing a subterranean formation penetrated by a well, the method comprising, injecting a fracturing fluid into the formation at a first pressure sufficient to create or enlarge a fracture having a first surface area; injecting into the formation a flow of the diverter fluid of any one or more of embodiments 1 to 12, wherein the flow of diverter fluid proceeds from a highly conductive zone to a less conductive zone; and injecting into the formation additional fracturing fluid at a second pressure, wherein the second pressure is greater than the first pressure to increase a surface area of the fracture to a second surface area, wherein the second fracture area is greater than a fracture area created from a substantially similar method without employing the injecting into the formation the flow of the diverter fluid.

### Embodiment 35

A method of hydraulically fracturing a subterranean formation penetrated by a well, the method comprising, injecting a fluid into the formation at a pressure sufficient to create or enlarge a primary fracture; monitoring an operational parameter and comparing the operational parameter after injecting of the fluid into the formation with a pre-determined value for the operational parameter, wherein the operational parameter is the injection rate of the fluid, the density of the fluid, and the bottomhole treating pressure of the well; injecting the diverter fluid of any one or more of embodiments 1 to 12 to divert the flow of fluid from a highly conductive zone to a less conductive zone; comparing the operational parameter injecting the diverter fluid with the pre-determined value for the operational parameter; injecting a flow of a fracturing fluid into the formation, wherein the flow of the fracturing fluid to the less conductive zone is impeded by the diverting agent to increase a surface area of the primary fracture.

### Embodiment 36

The method of any one or more of embodiments 29 to 35, wherein the subterranean formation is a hydrocarbon-bearing formation.

### Embodiment 37

The method of any one or more of embodiments 29 to 36, wherein the subterranean formation is shale.

### Embodiment 38

The method of any one or more of embodiments 29 to 37, wherein each of the steps of the methods are continuous.

All ranges disclosed herein are inclusive of the endpoints, and the endpoints are independently combinable with each other. “Combination” is inclusive of blends, mixtures, alloys, reaction products, and the like. The term “(meth)acryl” is inclusive of both acryl and methacryl. Furthermore, the terms “first,” “second,” and the like, herein do not denote any order, quantity, or importance, but rather are used to denote one element from another. The modifier “about” used in connection with a quantity is inclusive of the stated value and has the meaning dictated by the context (e.g., it includes the degree of error associated with measurement of the particular quantity). The terms “a” and “an” and “the” herein do not denote a limitation of quantity, and are to be construed to cover both the singular and the plural, unless otherwise indicated herein or clearly contradicted by context. “Or” means “and/or” unless otherwise indicated herein or clearly contradicted by context. In general, the invention can alternatively comprise, consist of, or consist essentially of, any appropriate components herein disclosed. The invention can additionally, or alternatively, be formulated so as to be devoid, or substantially free, of any components, materials, ingredients, adjuvants or species used in the prior art compositions or that are otherwise not necessary to the achievement of the function and/or objectives of the present invention. Embodiments herein can be used independently or can be combined.

All references are incorporated herein by reference.

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

1. A diverter fluid, comprising
an aqueous carrier fluid; and
a plurality of water-swellable polymer particles having a size of 0.01 to 100,000 micrometers.

2. The diverter fluid of claim 1, wherein the polymer particles are swellable to an average diameter of 1.1 to 1000 times greater than that of the same polymer particles that have not been swelled.

3. The diverter fluid of claim 1, wherein the polymer particles are fully swelled after contacting the aqueous diverter carrier fluid for 5 to 60 minutes.

4. The diverter fluid of claim 1, wherein the polymer particles are fully swelled after contacting the aqueous diverter carrier fluid for 1 to 36 hours.

5. The diverter fluid of claim 1, wherein the polymer particles are present in the diverter fluid in a concentration of 0.1 to 200 pounds per thousand gallons.

6. The diverter fluid of claim 1, wherein the polymer particles comprise a polysaccharide, poly(hydroxyC₁₋₈ alkyl (meth)acrylate)s such as poly(2-hydroxyethyl acrylate), poly(C₁₋₈ alkyl (meth)acrylate)s, poly((meth)acrylamide)s, poly(vinyl pyrrolidine), poly(vinyl acetate), or a combination comprising at least one of the foregoing.

7. The diverter fluid of claim 1, wherein the diverter carrier fluid comprises fresh water, brine, aqueous acid, aqueous base, or a combination comprising at least one of the foregoing.

8. The diverter fluid of claim 1, wherein the diverter fluid further comprises one or more of:
a lightweight particulate different from the water-swellable polymer particles, wherein the lightweight particulate has an apparent specific gravity of less than or equal to 3.25;
an oxidative breaker; and
an additional diverter different from the water-swellable polymer particles, preferably phthalic anhydride, polylactic acid, phthalic acid, rock salt, benzoic acid flakes, ground-up dissolvable ballsealers comprising collagen, ester-containing compounds, sodium chloride grains, polyglycolic acid, and combinations comprising at least one of the foregoing.

9. A method of controlling the downhole placement of a diverting agent in a subterranean formation, the method comprising,
injecting into the formation the diverter fluid of claim 1,
wherein the aqueous carrier fluid is selected so that the polymer particles are fully swelled after contacting the aqueous carrier fluid for an amount of time sufficient to achieve a desired downhole placement.

10. The method of claim 9,
wherein the carrier fluid is a low viscosity fluid comprising slickwater, freshwater, brine, aqueous acid, aqueous base, or a combination comprising at least one of the foregoing;
wherein the polymer particles are fully swelled after contacting the aqueous carrier fluid for 5 to 60 minutes; and
wherein the desired downhole placement is near wellbore.

11. The method of claim 9,
wherein the carrier fluid is a high viscosity fluid comprising a gelled fluid or a foam;
wherein the polymer particles are fully swelled after contacting the aqueous carrier fluid for 1 to 36 hours; and
wherein the desired downhole placement is far field from a wellbore.

12. The method of claim 9, wherein the aqueous carrier fluid has a pH of 0 to 14 and the polymer particles are fully swelled after contacting the aqueous carrier fluid for 5 minutes to 36 hours.

13. A method of hydraulically fracturing a subterranean formation penetrated by a reservoir or a well, the method comprising
injecting a fracturing fluid into the formation at a pressure sufficient to create or enlarge a fracture;
injecting the diverter fluid of claim 1 into the formation; and
injecting a fracturing fluid into the formation, wherein the flow of the fracturing fluid is impeded by the diverting agent and a surface fracture area of the fracture is increased.

14. The method of claim 13, wherein a desired downhole placement of the diverting agent in the subterranean formation is achieved by the method of claim 9.

15. The method of claim 13, further comprising
monitoring an operational parameter, wherein the operational parameter is the injection rate of the fluid, the density of the fluid, the bottomhole treating pressure of the well, or the surface pressure at or near the surface of the well; and
comparing the operational parameter after injecting of the diverter fluid into the formation with a pre-determined value for the operational parameter.

16. The method of claim 13, further comprising altering a stress in the well to increase the surface area of the fracture, wherein altering is by varying an injection rate of the fracturing fluid, varying the bottomhole pressure of the well, varying the density of the fracturing fluid, or a combination comprising at least one of the foregoing.

17. The method of claim 13, wherein
injecting the fracturing fluid into the formation is at a first pressure;
a flow of the diverter fluid proceeds from a highly conductive zone to a less conductive zone; and
injecting into the formation additional fracturing fluid is at a second pressure, wherein the second pressure is greater than the first pressure to increase a surface area of the fracture to a second surface area, wherein the second fracture area is greater than a fracture area created from a substantially similar method without employing the injecting into the formation the flow of the diverter fluid.

18. The method of claim 13, wherein the subterranean formation is a hydrocarbon-bearing formation.

19. The method of claim 13, wherein the subterranean formation is shale.

20. The method of claim 13, wherein each of the steps of the methods are continuous.
